(19) United States
(12) Patent Application Publication
(10) Pub. No.: US 2010/0178513 A1
(43) Pub. Date: Jul. 15, 2010

(54) Process for Producing Odor-Inhibiting Water-Absorbing Polymer Particles

(75) Inventors: Volker Braig, Weinheim-Lutzelsachsen (DE); Thomas Daniel, Waldsee (DE); Axel Jentzsch, Ludwigshafen (DE); Andreas Brockmeyer, Alsbach-Hahnlein (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: BASF SE, Ludwigshafen (DE)

(21) Appl. No.: 12/683,956

(22) Filed: Jan. 7, 2010

Related U.S. Application Data
(60) Provisional application No. 61/143,436, filed on Jan. 9, 2009.

(51) Int. Cl. B32B 27/00; C08F 20/06; C08L 67/00

(52) U.S. Cl. 428/407; 526/317.1; 525/418; 524/599

(57) ABSTRACT

A process for producing odor-inhibiting water-absorbing polymer particles based on ethylenically unsaturated monomer bearing acid groups, said acid groups having been neutralized to an extent of 40 to 70 mol % and the polymer particles being coated with a chelating agent.

The invention relates to a process for producing odor-inhibiting water-absorbing polymer particles based on ethylenically unsaturated monomers bearing acid groups, wherein the acid groups have been neutralized to an extent of from 40 to 70 mol % and the polymer particles are coated with a chelating agent

The production of water-absorbing polymer particles is described in the monograph “Modern Superabsorbent Polymer Technology”, F. L. Buchholz and A. T. Graham, Wiley-VCH, 1998, pages 71 to 103.

Water-absorbing polymers are used to produce diapers, tampons, sanitary napkins and other hygiene articles, but also as water-retaining agents in market gardening.

WO 2006/109842 A1 describes a process for producing water-absorbing polymer particles, wherein a monomer solution with a defined content of hydroquinone monomethyl ether and iron and a small amount of protoanemonin and furfural is polymerized.

It was an object of the present invention to provide an improved process for producing odor-inhibiting water-absorbing polymer particles.

The object is achieved by a process for producing water-absorbing polymer particles, comprising
i) the neutralization of at least one ethylenically unsaturated monomer bearing acid groups with a base up to a degree of neutralization of from 40 to 70 mol %, the base comprising less than 0.0005% by weight of iron ions and the lines used to convey the base being made of stainless steel or a polymeric material,
ii) polymerization of the neutralized monomer in the presence of at least one crosslinker and of at least one initiator, the initiator being essentially free of iron ions,
iii) drying of the resulting polymer gel,
iv) comminution of the dried polymer gel to polymer particles,
v) classification of the resulting polymer particles and
vi) optional surface postcrosslinking of the classified polymer particles,
   the polymer particles being coated with from 0.01 to 1% by weight of at least one chelating agent.

The degree of neutralization is preferably from 45 to 65 mol %, more preferably from 48 to 62 mol %, most preferably from 50 to 60 mol %.

The base comprises preferably less than 0.0001% by weight, more preferably less than 0.00002% by weight, and most preferably less than 0.00001% by weight, of iron ions.

Suitable stainless steels are austenitic steels with, for example, at least 0.08% by weight of carbon. The austenitic steels advantageously comprise, as well as iron, carbon, chromium, nickel and optionally molybdenum, also further alloy constituents, preferably niobium or titanium.

The preferred stainless steels are stainless steels with materials number 1.45xx according to DIN EN 10020, where xx may be a natural number from 0 to 99. Particularly preferred materials are the steels with materials numbers 1.4541 and 1.4571, especially steel with materials number 1.4541.

Suitable polymeric materials are polyethylene, polypropylene, polyester, polyamide, polytetrafluoroethylene, polyvinyl chloride, epoxy resins and silicone resins. Very particular preference is given to polypropylene.

The initiator systems used are essentially free of iron ions, the initiator systems used comprising preferably less than 0.1% by weight, more preferably less than 0.01% by weight, and most preferably less than 0.001% by weight, or iron ions, based in each case on the total amount of the initiator system.

Chelating agents are compounds having at least two functional groups capable of chelate formation with polyvalent metal ions.

Suitable chelating agents are, for example, ethylenediamine, diethylenetriamine, triethylenetetramine, iminodiacetic acid, 2,2′,2″-triaminotriethylamine, nitrilotriacetic acid, ethylenediaminetetraacetic acid, oxalic acid, tartaric acid, citric acid, dimethyl glyoxime, 8-hydroxyquinoline, 2,2′-bipyridine, 1,10-phenanthroline, dimercaptosuccinic acid.

Preferred functional groups are acid groups, especially carboxylic acid groups.

The at least one chelating agent comprises preferably at least one aminocarboxylic acid group, more preferably at least two aminocarboxylic acid groups.

The aminocarboxylic acid group is preferably an aminodiacetic acid group.

The acid groups of the chelating agent have preferably been neutralized, i.e. the chelating agent is preferably used in neutralized form.

Suitable chelating agents with aminodiacetic acid groups are, for example, the tetrasodium salt of ethylenediaminetetraacetic acid, the trisodium salt of methylglycinediacetic acid, the trisodium salt of hydroxyethylethylenediamine-triacetic acid and the pentasodium salt of diethylenediaminepentaacetic acid.

The polymer particles are preferably coated with from 0.02 to 0.5% by weight, more preferably from 0.05 to 0.3% by weight, and most preferably from 0.1 to 0.2% by weight, of chelating agent.

The coating of the polymer particles is preferably performed by means of mixers with moving mixing tools. The mixers usable for surface postcrosslinking can also be used for the inventive coating.

It is possible to coat the polymer particles obtained after the classification v) or obtained after the optional surface postcrosslinking vi) with a complexing agent. In addition, it is possible to perform the coating simultaneously with the surface postcrosslinking.

For coating onto the polymer particles, the chelating agents are preferably sprayed on as a solution in a suitable solvent, preferably water.

In a preferred embodiment of the present invention, the water-absorbing polymer particles are coated with a reducing agent and/or a zinc salt.

Suitable reducing agents are for example, sodium sulfite, sodium hydrogensulfite (sodium bisulfite), sodium dithionite, sulfinic acids and salts thereof, ascorbic acid, sodium hypophosphite, sodium phosphite, and phosphinic acids and salts thereof. Preference is given, however, to using salts of hypophosphorous acid for example sodium hypophosphite, and salts of sulfinic acids, for example the disodium salt of 2-hydroxy-2-sulfinatoacetic acid. However, the reducing agent used is preferably a mixture of the sodium salt of 2-hydroxy-2-sulfinatoacetic acid, the disodium salt of 2-hydroxy-2-sulfonatoacetic acid and sodium bisulfite. Such mixtures are available as Brüggolite® FF6 and Brüggolite® FF7 (Brüggemann Chemicals; Heilbronn; Germany).

The amount of reducing agent used is preferably from 0.01 to 5% by weight, more preferably from 0.05 to 2% by weight, and most preferably from 0.1 to 1% by weight, in each case based on the water-absorbing polymer.

Suitable zinc salts are, for example, zinc hydroxide, zinc sulfate, zinc chloride, zinc acetate and zinc lactate. Preference is given to using zinc salts of fatty acids, for example of ricinoleic acid.

The amount of zinc salt used is preferably from 0.01 to 5% by weight, more preferably from 0.05 to 2% by weight, and most preferably from 0.1 to 1% by weight, based in each case on the water-absorbing polymer.

The reducing agents and/or zinc salts are typically used in the form of a solution in a suitable solvent, preferably water.

The present invention is based on the finding that the combination of slightly acidic water-absorbing polymer particles with chelating agents leads to significantly improved odor inhibition. The chelating agents are thought to deactivate urease by complexing the essential nickel ions. At the same time, iron ions present in the water-absorbing polymer particles compete for the chelating agents. Furthermore, iron ions present in conjunction with chelating agents may also be the cause of undesired discoloration. Strict control of the amount of iron ions makes it possible to provide water-absorbing polymer particles which firstly have good odor inhibition and secondly comprise only a small amount of chelating agent.

An example of a possible source for iron ions is sodium hydroxide solution, which is frequently used as a base. To perform the process according to the invention it should be ensured that the sodium hydroxide solution used has a minimum proportion of iron ions.

In addition, the pipelines in which the base is sent to the neutralization are critical. For instance, sodium hydroxide solution is not considered to be corrosive with respect to unalloyed steels and is even used for passivation. However, sodium hydroxide solution leaches small traces of iron ions from unalloyed steels. The base therefore has to be conveyed into the neutralization by means of a pipeline made of stainless steel. Owing to the associated lower input of iron ions, it is advantageous also to use stainless steel or a polymeric material as the material for the remaining plant parts of the preparation process which are in contact with the product.

Moreover, it should be ensured that an initiator system is used, in which substantially no iron ions are used as a catalyst.

Additional coating of the polymer particles with reducing agents and/or zinc salts allows the discoloration tendency to be influenced favorably.

The production of the water-absorbing polymer particles is described in detail hereinafter.

The water-absorbing polymer particles are produced, for example, by polymerizing a monomer solution or suspension comprising
a) at least one ethylenically unsaturated monomer bearing acid groups wherein the acid groups have been neutralized to an extent of from 40 to 70 mol %,
b) at least one crosslinker,
c) at least one initiator,
d) optionally one or more ethylenically unsaturated monomers copolymerizable with the monomers mentioned under a) and
e) optionally one or more water-soluble polymers, and are typically water-insoluble.

The monomers a) are preferably water-soluble, i.e. the solubility in water at 23° C. is typically at least 1 g/100 g of water, preferably at least 5 g/100 g of water, more preferably at least 25 g/100 g of water, most preferably at least 35 g/100 g of water.

Suitable monomers a) are, for example, ethylenically unsaturated carboxylic acids, such as acrylic acid, methacrylic acid and itaconic acid. Particularly preferred monomers are acrylic acid and methacrylic acid. Very particular preference is given to acrylic acid.

Further suitable monomers a) are, for example, ethylenically unsaturated sulfonic acids, such as styrenesulfonic acid and 2-acrylamido-2-methylpropanesulfonic acid (AMPS).

Impurities can have a considerable influence on the polymerization. The raw materials used should therefore have a maximum purity. It is therefore often advantageous to specially purify the monomers a). Suitable purification processes are described, for example, in WO 2002/055469 A1, WO 2003/078378 A1 and WO 2004/035514 A1. A suitable monomer a) is, for example, acrylic acid purified according to WO 2004/035514 A1 comprising 99.8460% by weight of acrylic acid, 0.0950% by weight of acetic acid, 0.0332% by weight of water, 0.0203% by weight of propionic acid, 0.0001% by weight of furfurals, 0.0001% by weight of maleic anhydride, 0.0003% by weight of diacrylic acid and 0.0050% by weight of hydroquinone monomethyl ether.

The proportion of acrylic acid and/or salts thereof in the total amount of monomers a) is preferably at least 50 mol %, more preferably at least 90 mol %, most preferably at least 95 mol %.

The monomers a) typically comprise polymerization inhibitors, preferably hydroquinone monoethers, as storage stabilizers.

The monomer solution comprises preferably up to 250 ppm by weight, preferably at most 130 ppm by weight, more preferably at most 70 ppm by weight, preferably at least 10 ppm by weight, more preferably at least 30 ppm by weight, especially around 50 ppm by weight, of hydroquinone monoether, based in each case on the unneutralized monomer a). For example, the monomer solution can be prepared by using an ethylenically unsaturated monomer bearing acid groups with an appropriate content of hydroquinone monoether.

Preferred hydroquinone monoethers are hydroquinone monomethyl ether (MEHQ) and/or alpha-tocopherol (vitamin E).

Suitable crosslinkers b) are compounds having at least two groups suitable for crosslinking. Such groups are, for example, ethylenically unsaturated groups which can be polymerized free-radically into the polymer chain, and functional groups which can form covalent bonds with the acid groups of the monomer a). In addition, polyvalent metal salts which can form coordinate bonds with at least two acid groups of the monomer a) are also suitable as crosslinkers b).

Crosslinkers b) are preferably compounds having at least two polymerizable groups which can be polymerized free-radically into the polymer network. Suitable crosslinkers b) are, for example, ethylene glycol dimethacrylate, diethylene glycol diacrylate, polyethylene glycol diacrylate, allyl methacrylate, trimethylolpropane triacrylate, triallylamine, tetraallylammonium chloride, tetraallyloxyethane, as described in EP 0 530 438 A1, di- and triacrylates, as described in EP 0 547 847 A1, EP 0 559 476 A1, EP 0 632 068 A1, WO 93/21237 A1, WO 2003/104299 A1, WO 2003/104300 A1, WO 2003/104301 A1 and DE 103 31 450 A1, mixed acrylates which, as well as acrylate groups, comprise further ethylenically unsaturated groups, as described in DE 103 31 456 A1 and DE 103 55 401 A1, or crosslinker mixtures, as described, for example, in DE 195 43 368 A1, DE 196 46 484 A1, WO 90/15830 A1 and WO 2002/032962 A2.

Preferred crosslinkers b) are pentaerythrityl Wally' ether, tetraalloxyethane, methylenebismethacrylamide, 15-tuply ethoxylated trimethylolpropane triacrylate, polyethylene glycol diacrylate, trimethylolpropane triacrylate and triallylamine.

Very particularly preferred crosslinkers b) are the polyethoxylated and/or -propoxylated glycerols which have been esterified with acrylic acid or methacrylic acid to give di- or triacrylates, as described, for example, in WO 2003/104301 A1. Di- and/or triacrylates of 3- to 10-tuply ethoxylated glycerol are particularly advantageous. Very particular preference is given to di- or triacrylates of 1- to 5-tuply ethoxylated and/or propoxylated glycerol. Most preferred are the triacrylates of 3- to 5-tuply ethoxylated and/or propoxylated glycerol, especially the triacrylate of 3-tuply ethoxylated glycerol.

The amount of crosslinker b) is preferably from 0.05 to 1.5% by weight, more preferably from 0.1 to 1% by weight, most preferably from 0.3 to 0.6% by weight, based in each case on monomer a). With rising crosslinker content, the centrifuge retention capacity (CRC) falls and the absorption under a pressure of 21.0 g/cm² passes through a maximum.

The initiators c) may be all compounds which generate free radicals under the polymerization conditions, for example thermal initiators, redox initiators, photoinitiators. Suitable redox initiators are sodium peroxodisulfate/ascorbic acid, hydrogen peroxide/ascorbic acid, sodium peroxodisulfate/sodium bisulfite and hydrogen peroxide/sodium bisulfite. Preference is given to using mixtures of thermal initiators and redox initiators, such as sodium peroxodisulfate/hydrogen peroxide/ascorbic acid. The reducing component used is, however, preferably a mixture of the sodium salt of 2-hydroxy-2-sulfinatoacetic acid, the disodium salt of 2-hydroxy-2-sulfonatoacetic acid and sodium bisulfite. Such mixtures are obtainable as Brüggolite® FF6 and Brüggolite® FF7 (Brüggemann Chemicals; Heilbronn; Germany).

Ethylenically unsaturated monomers d) copolymerizable with the ethylenically unsaturated monomers a) bearing acid groups are, for example, acrylamide, methacrylamide, hydroxyethyl acrylate, hydroxyethyl methacrylate, dimethylaminoethyl methacrylate, dimethylaminoethyl acrylate, dimethylaminopropyl acrylate, diethylaminopropyl acrylate, dimethylaminoethyl methacrylate, diethylaminoethyl methacrylate.

The water-soluble polymers e) used may be polyvinyl alcohol, polyvinylpyrrolidone, starch, starch derivatives, modified cellulose, such as methylcellulose or hydroxyethylcellulose, gelatin, polyglycols or polyacrylic acids, preferably starch, starch derivatives and modified cellulose.

Typically, an aqueous monomer solution is used. The water content of the monomer solution is preferably from 40 to 75% by weight, more preferably from 45 to 70% by weight, most preferably from 50 to 65% by weight. It is also possible to use monomer suspensions, i.e. monomer solutions with excess monomer a), for example sodium acrylate. With rising water content, the energy requirement in the subsequent drying rises, and, with falling water content, the heat of polymerization can only be removed inadequately.

For optimal action, the preferred polymerization inhibitors require dissolved oxygen. The monomer solution can therefore be freed of dissolved oxygen before the polymerization by inertization, i.e. flowing an inert gas through, preferably nitrogen or carbon dioxide. The oxygen content of the monomer solution is preferably lowered before the polymerization to less than 1 ppm by weight, more preferably to less than 0.5 ppm by weight, most preferably to less than 0.1 ppm by weight.

Suitable reactors are, for example, kneading reactors or belt reactors. In the kneader, the polymer gel formed in the polymerization of an aqueous monomer solution or suspension is comminuted continuously by, for example, contrarotatory stirrer shafts, as described in WO 2001/038402 A1. Polymerization on a belt is described, for example, in DE 38 25 366 A1 and U.S. Pat. No. 6,241,928. Polymerization in a belt reactor forms a polymer gel, which has to be comminuted in a further process step, for example in an extruder or kneader.

However, it is also possible to dropletize an aqueous monomer solution and to polymerize the droplets produced in a heated carrier gas stream. In this case, the process steps of polymerization and drying can be combined, as described in WO 2008/040715 A2 and WO 2008/052971 A1.

The acid groups of the resulting polymer gels have typically been partially neutralized. Neutralization is preferably carried out at the monomer stage. This is typically done by mixing in the neutralizing agent as an aqueous solution or preferably also as a solid. The degree of neutralization is preferably from 45 to 65 mol %, more preferably from 48 to 62 mol %, most preferably from 50 to 60 mol %, for which the customary neutralizing agents can be used, preferably alkali metal hydroxides, alkali metal oxides, alkali metal carbonates or alkali metal hydrogencarbonates and also mixtures thereof. Instead of alkali metal salts, it is also possible to use ammonium salts. Particularly preferred alkali metals are sodium and potassium, but very particular preference is given to potassium hydroxide, sodium hydroxide, sodium carbonate or sodium hydrogencarbonate and also mixtures thereof.

However, it is also possible to carry out neutralization after the polymerization, at the stage of the polymer gel formed in the polymerization. It is also possible to neutralize up to 40 mol %, preferably from 10 to 30 mol % and more preferably from 15 to 25 mol % of the acid groups before the polymerization by adding a portion of the neutralizing agent actually to the monomer solution and setting the desired final degree of neutralization only after the polymerization, at the polymer gel stage. When the polymer gel is neutralized at least partly after the polymerization, the polymer gel is preferably comminuted mechanically, for example by means of an extruder, in which case the neutralizing agent can be sprayed, sprinkled or poured on and then carefully mixed in. To this end, the gel mass obtained can be repeatedly extruded for homogenization.

The polymer gel is then preferably dried with a belt drier until the residual moisture content is preferably from 0.5 to 15% by weight, more preferably from 1 to 10% by weight, most preferably from 2 to 8% by weight, the residual moisture content being determined by the EDANA (European Disposables and Nonwovens Association) recommended test method No. WSP 230.2-05 “Moisture Content”. In the case of too high a residual moisture content, the dried polymer gel has too low a glass transition temperature T_{g} and can be processed further only with difficulty. In the case of too low a residual moisture content, the dried polymer gel is too brittle and, in the subsequent comminution steps, undesirably large amounts of polymer particles with an excessively low particle size are obtained (“fines”). The solids content of the gel before the drying is preferably from 25 to 90% by weight, more preferably from 35 to 70% by weight, most preferably from 40 to 60% by weight. Optionally, it is, however, also possible to use a fluidized bed drier or a paddle drier for the drying operation.

Thereafter, the dried polymer gel is ground and classified, and the apparatus used for grinding may typically be single- or multistage roll mills, preferably two- or three-stage roll mills, pin mills, hammer mills or vibratory mills.

The mean particle size of the polymer particles removed as the product fraction is preferably at least 200 μm, more preferably from 250 to 600 μm, very particularly from 300 to 500 μm. The mean particle size of the product fraction may be determined by means of the EDANA (European Disposables and Nonwovens Association) recommended test method No. WSP 220.2-05 “Particle Size Distribution”, where the proportions by mass of the screen fractions are plotted in cumulated form and the mean particle size is determined graphically. The mean particle size here is the value of the mesh size which gives rise to a cumulative 50% by weight.

The proportion of particles with a particle size of at least 150 μm is preferably at least 90% by weight, more preferably at least 95% by weight, most preferably at least 98% by weight.

Polymer particles with too small a particle size lower the permeability (SFC). The proportion of excessively small polymer particles (“fines”) should therefore be small.

Excessively small polymer particles are therefore typically removed and recycled into the process. This is preferably done before, during or immediately after the polymerization, i.e. before the drying of the polymer gel. The excessively small polymer particles can be moistened with water and/or aqueous surfactant before or during the recycling.

It is also possible to remove excessively small polymer particles in later process steps, for example after the surface postcrosslinking or another coating step. In this case, the excessively small polymer particles recycled are surface postcrosslinked or coated in another way, for example with fumed silica.

When a kneading reactor is used for polymerization, the excessively small polymer particles are preferably added during the last third of the polymerization.

When the excessively small polymer particles are added at a very early stage, for example actually to the monomer solution, this lowers the centrifuge retention capacity (CRC) of the resulting water-absorbing polymer particles. However, this can be compensated, for example, by adjusting the amount of crosslinker b) used.

When the excessively small polymer particles are added at a very late stage, for example not until in an apparatus connected downstream of the polymerization reactor, for example to an extruder, the excessively small polymer particles can be incorporated into the resulting polymer gel only with difficulty. Insufficiently incorporated, excessively small polymer particles are, however, detached again from the dried polymer gel during the grinding, are therefore removed again in the course of classification and increase the amount of excessively small polymer particles to be recycled.

The proportion of particles having a particle size of at most 850 μm is preferably at least 90% by weight, more preferably at least 95% by weight, most preferably at least 98% by weight.

The proportion of particles having a particle size of at most 600 μm is preferably at least 90% by weight, more preferably at least 95% by weight, most preferably at least 98% by weight.

Polymer particles with too great a particle size lower the swell rate. The proportion of excessively large polymer particles should therefore likewise be small.

Excessively large polymer particles are therefore typically removed and recycled into the grinding of the dried polymer gel.

To further improve the properties, the polymer particles can be surface postcrosslinked. Suitable surface postcrosslinkers are compounds which comprise groups which can form covalent bonds with at least two carboxylate groups of the polymer particles. Suitable compounds are, for example, polyfunctional-amines, polyfunctional amido amines, polyfunctional epoxides, as described in EP 0 083 022 A2, EP 0 543 303 A1 and EP 0 937 736 A2, di- or polyfunctional alcohols, as described in DE 33 14 019 A1, DE 35 23 617 A1 and EP 0 450 922 A2, or β-hydroxyalkylamides, as described in DE 102 04 938 A1 and U.S. Pat. No. 6,239,230.

Additionally described as suitable surface postcrosslinkers are cyclic carbonates in DE 40 20 780 C1, 2-oxazolidone and its derivatives, such as 2-hydroxyethyl-2-oxazolidone in DE 198 07 502 A1, bis- and poly-2-oxazolidinones in DE 198 07 992 C1,2-oxotetrahydro-1,3-oxazine and its derivatives in DE 198 54 573 A1, N-acyl-2-oxazolidones in DE 198 54 574 A1, cyclic ureas in DE 102 04 937 A1, bicyclic amide, acetals in DE 103 34 584 A1, oxetanes and cyclic ureas in EP 1 199 327 A2 and morpholine-2,3-dione and its derivatives in WO 2003/031482 A1.

Preferred surface postcrosslinkers are ethylene carbonate, ethylene glycol diglycidyl ether, reaction products of polyamides with epichlorohydrin and mixtures of propylene glycol and 1,4-butanediol.

Very particularly preferred surface postcrosslinkers are 2-hydroxyethyloxazolidin-2-one, oxazolidin-2-one and 1,3-propanediol.

In addition, it is also possible to use surface postcrosslinkers which comprise additional polymerizable ethylenically unsaturated groups, as described in DE 37 13 601 A1.

The amount of surface postcrosslinkers is preferably from 0.001 to 2% by weight, more preferably from 0.02 to 1% by weight and most preferably from 0.05 to 0.2% by weight, based in each case on the polymer particles.

In a preferred embodiment of the present invention, polyvalent cations are applied to the particle surface in addition to the surface postcrosslinkers before, during or after the surface postcrosslinking.

The polyvalent cations usable in the process according to the invention are, for example, divalent cations such as the cations of zinc, magnesium, calcium, iron and strontium, trivalent cations such as the cations of aluminum, iron, chromium, rare earths and manganese, tetravalent cations such as the cations of titanium and zirconium. Possible counterions are chloride, bromide, sulfate, hydrogensulfate, carbonate, hydrogencarbonate, nitrate, phosphate, hydrogenphosphate, dihydrogenphosphate and carboxylate, such as acetate and lactate. Aluminum sulfate and aluminum lactate are preferred. Apart from metal salts, it is also possible to use polyamines as polyvalent cations.

The amount of polyvalent cation used is, for example, from 0.001 to 1.5% by weight, preferably from 0.005 to 1% by weight, more preferably from 0.02 to 0.8% by weight, based in each case on the polymer particles.

The surface postcrosslinking is typically performed in such a way that a solution of the surface postcrosslinker is sprayed onto the dried polymer particles. After the spraying, the polymer particles coated with surface postcrosslinker are dried thermally, and the surface postcrosslinking reaction can take place either before or during the drying.

The spraying of a solution of the surface postcrosslinker is preferably performed in mixers with moving mixing tools, such as screw mixers, disk mixers and paddle mixers. Particular preference is given to horizontal mixers such as paddle mixers, very particular preference to vertical mixers. The distinction between horizontal mixers and vertical mixers is made by the position of the mixing shaft, i.e. horizontal mixers have a horizontally mounted mixing shaft and vertical mixers a vertically mounted mixing shaft. Suitable mixers are, for example, horizontal Pflugschar® plowshare mixers (Gebr. Lödige Maschinenbau GmbH; Paderborn; Germany), Vrieco-Nauta continuous mixers (Hosokawa Micron By; Doetinchem; the Netherlands), Processall Mixmill mixers (Processall Incorporated; Cincinnati; US) and Schugi Flexomix® (Hosokawa Micron BV; Doetinchem; the Netherlands). However, it is also possible to spray on the surface postcrosslinker solution in a fluidized bed or to use the mixer disclosed in WO 2008/141821 A2.

The surface postcrosslinkers are typically used in the form of an aqueous solution. The penetration depth of the surface postcrosslinker into the polymer particles can be adjusted via the content of nonaqueous solvent and total amount of solvent.

When exclusively water is used as the solvent, a surfactant is advantageously added. This improves the wetting behavior and reduces the tendency to form lumps. However, preference is given to using solvent mixtures, for example isopropanol/water, 1,3-propanediol/water and propylene glycol/water, where the mixing ratio in terms of mass is preferably from 20:80 to 40:60.

The thermal drying is preferably carried out in contact driers, more preferably paddle driers, most preferably disk driers. Suitable driers are, for example, Hosokawa Bepex® horizontal paddle driers (Hosokawa Micron GmbH; Leingarten; Germany), Hosokawa Bepex® disk driers (Hosokawa Micron GmbH; Leingarten; Germany) and Nara paddle driers (NARA Machinery Europe; Frechen; Germany). Moreover, it is also possible to use fluidized bed driers.

The drying can be effected in the mixer itself, by heating the jacket or blowing in warm air. Equally suitable is a downstream drier, for example a shelf drier, a rotary tube oven or a heatable screw. It is particularly advantageous to mix and dry in a fluidized bed drier.

Preferred drying temperatures are in the range from 100 to 250° C., preferably from 120 to 220° C., more preferably from 130 to 210° C., most preferably from 150 to 200° C. The preferred residence time at this temperature in the reaction mixer or drier is preferably at least 10 minutes, more preferably at least 20 minutes, most preferably at least 30 minutes, and typically at most 60 minutes.

Subsequently, the surface postcrosslinked polymer particles can be classified again, excessively small and/or excessively large polymer particles being removed and recycled into the process.

To further improve the properties, the surface postcrosslinked polymer particles can be coated or subsequently moistened.

The subsequent moistening is carried out preferably at from 30 to 80° C., more preferably at from 35 to 70° C. and most preferably at from 40 to 60° C. At excessively low temperatures, the water-absorbing polymer particles tend to form lumps, and, at higher temperatures, water already evaporates noticeably. The amount of water used for subsequent moistening is preferably from 1 to 10% by weight, more preferably from 2 to 8% by weight and most preferably from 3 to 5% by weight. The subsequent moistening increases the mechanical stability of the polymer particles and reduces their tendency to static charging.

Suitable coatings for improving the swell rate and the permeability (SFC) are, for example, inorganic inert substances, such as water-insoluble metal salts, organic polymers, cationic polymers and di- or polyvalent metal cations. Suitable coatings for dust binding are, for example, polyols. Suitable coatings for counteracting the undesired caking tendency of the polymer particles are, for example, fumed silica, such as Aerosil® 200, and surfactants, such as Span® 20.

The present invention further provides the water-absorbing polymer particles produced by the process according to the invention.

The water-absorbing polymer particles produced by the process according to the invention have a low content of iron ions. The content of iron ions is less than 0.001% by weight, preferably less than 0.0005% by weight, more preferably less than 0.0001% by weight and most preferably less than 0.00002% by weight.

Also important is a sufficient excess of a chelating agent compared to the iron ions. The weight ratio of iron ions to chelating agent is less than 0.02, preferably less than 0.01, more preferably less than 0.005 and most preferably less than 0.001.

The water-absorbing polymer particles produced by the process according to the invention have a moisture content of preferably from 1 to 10% by weight, more preferably from 2 to 8% by weight, most preferably from 3 to 5% by weight, the water content being determined by the EDANA (European Disposables and Nonwovens Association) recommended test method No. WSP 230.2-05 “Moisture Content”.

The water-absorbing polymer particles produced by the process according to the invention have a centrifuge retention capacity (CRC) of typically at least 15 g/g, preferably at least 20 g/g, preferentially at least 22 g/g, more preferably at least 24 g/g, most preferably at least 26 g/g. The centrifuge retention capacity (CRC) of the water-absorbing polymer particles is typically less than 60 g/g. The centrifuge retention capacity (CRC) is determined by the EDANA (European Disposables and Nonwovens Association) recommended test method No. WSP 241.2-05 “Centrifuge Retention Capacity”.

The water-absorbing polymer particles produced by the process according to the invention have an absorption under a pressure of 49.2 g/cm² of typically at least 15 g/g, preferably at least 20 g/g, preferentially at least 22 g/g, more preferably at least 24 g/g, most preferably at least 26 g/g. The absorption under a pressure of 49.2 g/cm² of the water-absorbing polymer particles is typically less than 35 g/g. The absorption under a pressure of 49.2 g/cm² is determined analogously to the EDANA (European Disposables and Nonwovens Association) recommended test method No. WSP 242.2-05 “Absorption under Pressure”, except that a pressure of 49.2 g/cm² is established instead of a pressure of 21.0 g/cm².

### EXAMPLES

The following solutions were prepared:
1. 1.67 g of 2,2′-bipyridine (CAS no. [366-18-7]; Acros Organics BVBA; Geel; Belgium) were weighed into a wide-neck glass vessel, made up to 10.02 g with ethanol and stirred until complete dissolution,
2. 0.167 g of iron sulfate hydrate (86.0-89.0% FeSO₄; CAS no. [13463-43-9]; Riedel-de Häen) were weighed into a wide-neck glass vessel, made up to 10.10 g with dist. water and stirred until complete dissolution.
3. 5.0 g each of the 2,2′-bipyridine solution and of the iron sulfate solution were mixed.

20.0 g of water-absorbing polymer particles (HySorb® 87065; BASF SE; Germany) were introduced into a modified coffee grinder (Blender 8012 Model 34BL99; Waring Laboratory; US) with an attachment made of stainless steel (internal diameter 8 cm, internal height 4 cm, tool diameter 7 cm, addition point in the lid 1.3 cm from the edge, baffles in the lid). The modified coffee grinder was operated at level 3. A syringe with a cannula was used to slowly add 0.60 g of solution 1 or 2 or 1.20 g of solution 3. After the end of the addition, the water-absorbing polymer particles were transferred to a glass dish and dried at 50° C. in a drying cabinet for 30 minutes.

The color of the samples was analyzed with a spectrophotometer (LabScan XE; Hunter Associates Laboratory, Inc.; US). The water-absorbing polymer particles (SAPs) were introduced in the lid of a polystyrene Petri dish (internal diameter 3.9 cm) and analyzed with the following settings:

Pot size: 1.2 inches
Fewing Area: 1 inch

### Illuminant: C

### Observer: 2°

UV filter: nominal

### Stdz Mode 0/45

| SAP with | L | a | b |
|---|---|---|---|
| Solution 1 | 92.0 | −0.2 | 2.8 |
| Solution 2 | 89.3 | −0.3 | 3.4 |
| Solution 3 | 46.7 | 50.4 | 21.4 |

It can be seen that the water-absorbing polymer particles treated with solution 3 have a smaller L value and are thus less white.

1. A process for producing water-absorbing polymer particles, comprising
i) the neutralization of at least one ethylenically unsaturated monomer bearing acid groups with a base up to a degree of neutralization of 40 to 70 mol %, said base comprising less than 0.0005% by weight of iron ions, and the lines used to convey the base being made of stainless steel and/or a polymeric material,
ii) polymerizing the neutralized monomer in the presence of at least one crosslinker and of at least one initiator, said initiator being essentially free of iron ions,
iii) drying the resulting polymer gel,
iv) comminuting the dried polymer gel to polymer particles,
v) classifying the resulting polymer particles and
vi) optionally surface postcrosslinking the classified polymer particles,
said polymer particles being coated with 0.01 to 1% by weight of at least one chelating agent.

2. The process according to claim 1, wherein the polymer particles are coated with polyvalent cations.

3. The process according to claim 1 or 2, wherein the polymer particles are surface postcrosslinked with at least one compound which can form covalent bonds with at least two carboxylate groups of the water-absorbing polymer particles.

4. The process according to claim 3, wherein the surface postcrosslinked polymer particles are subsequently moistened with an aqueous solution.

5. The process according to any one of claims 1 to 4, wherein the polymer particles are coated with at least one reducing agent.

6. The process according to any one of claims 1 to 5, wherein the polymer particles are coated with at least one zinc salt.

7. Water-absorbing polymer particles obtainable by polymerizing an aqueous monomer solution or suspension comprising
a) at least one ethylenically unsaturated monomer bearing acid groups, said acid groups having been neutralized to an extent of 40 to 70 mol %,
b) at least one crosslinker and
c) at least one initiator,
said polymer particles comprising less than 0.001% by weight of iron ions and being coated with 0.01 to 1% by weight of at least one chelating agent, the weight ratio of iron ions to chelating agent being less than 0.02.

8. Polymer particles according to claim 7, which have been coated with polyvalent cations.

9. Polymer particles according to claim 7 or 8, which have been surface postcrosslinked with at least one compound which can form covalent bonds with at least two carboxylate groups of the water-absorbing polymer particles.

10. Polymer particles according to any one of claims 7 to 9, at least 95% of which have a particle size of 150 to 600 μm.

11. Polymer particles according to any one of claims 7 to 10, which have a moisture content of 1 to 10% by weight.

12. Polymer particles according to any one of claims 7 to 11, which have been coated with at least one reducing agent.

13. Polymer particles according to any one of claims 7 to 12, which have been coated with at least one zinc salt.

14. Polymer particles according to any one of claims 7 to 13, which have a centrifuge retention capacity of 15 to 60 g/g.

15. Polymer particles according to any one of claims 7 to 14, which have an absorption under a pressure of 49.2 g/cm² of 15 to 35 g/g.

16. A hygiene article comprising polymer particles according to any one of claims 7 to 15.
